(19) United States
(12) Patent Application Publication
(10) Pub. No.: US 2009/0151144 A1
(43) Pub. Date: Jun. 18, 2009

(54) METHOD FOR REMOVING HARDWARE PRESSED INTO A BORE

(76) Inventor: Edward H. Bittner, Madison, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/954,653

(22) Filed: Dec. 12, 2007

(51) Int. Cl. B23P 19/02; B23P 19/04

(52) U.S. Cl. 29/426.5; 29/234

(57) ABSTRACT

A method of removing a locking ring from a component includes welding at least one sacrificial tab to the locking ring while the locking ring is within a bore of a component and axially forcing the locking ring from the bore along the axis.

### BACKGROUND OF THE INVENTION

The present invention relates to a removal procedure for hardware pressed into a bore.

Hardware is often installed in a component for attachment of that component to an anchoring structure. The hardware may be manufactured of one material type while the component may be manufactured of another material.

One type of hardware often utilized in aerospace components is a stud which may thread into the structure then be locked into position with a locking ring which is pressed into the structure around the stud. The locking ring often includes serrations which facilitate cold flow of the component material so as to secure the locking ring and thereby retain the stud against rotation.

Removal of hardware from the component during overhaul and repair may be a time consuming, difficult and costly process. The conventional industry standard of machining the hardware out of the bore requires dedicated cutter tools that may risk damage to the hardware and components.

### SUMMARY OF THE INVENTION

A method of removing hardware from a bore according to an exemplary aspect of the present invention includes welding at least one sacrificial tab to the hardware while the hardware is within a bore of a component, the bore defined along an axis; and axially forcing the hardware from the bore along the axis.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1 is a general perspective view an exemplary rotary wing aircraft embodiment for use with one non-limiting aspect of the present invention;

FIG. 2 is a perspective view of a housing with hardware mounted within a bore therefore;

FIG. 3A is a sectional view of hardware which is removable through one non-limiting aspect of the present invention;

FIG. 3B is a perspective view of the hardware of FIG. 3A;

FIG. 4 is a perspective view of hardware which has been subjected to corrosion;

FIG. 5 is a block diagram illustrating steps to remove hardware according to one non-limiting aspect of the present invention;

FIG. 6A is a sectional view of hardware with an exemplary tool assembly mounted thereon;

FIG. 6B is a sectional view taken along line 6B-6B in FIG. 6A;

FIG. 6C is a sectional view with a slide hammer mounted to the hardware; and

FIG. 7 is a sectional view of another exemplary embodiment with a tool assembly that includes an integral slide hammer.

### DETAILED DESCRIPTION OF THE DISCLOSED EMBODIMENT

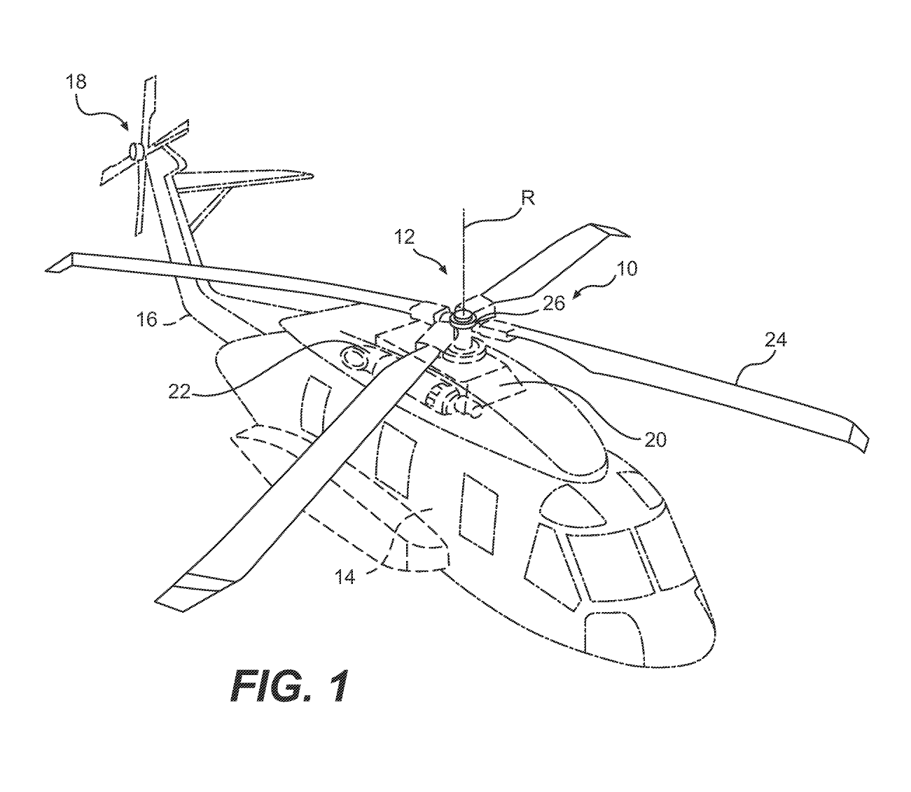

FIG. 1 schematically illustrates a rotary-wing aircraft 10 having a main rotor system 12. The aircraft 10 includes an airframe 14 having an extending tail 16 which mounts a tail rotor system 18, such as an anti-torque system. The main rotor assembly 12 is driven about an axis of rotation R through a main gearbox (illustrated schematically at 20) by one or more engines 22. The main rotor system 12 includes a multiple of rotor blades 24 mounted to a rotor hub 26. Although a particular helicopter configuration is illustrated and described in the disclosed embodiment, other configurations and/or machines, such as high speed compound rotary wing aircraft with supplemental translational thrust systems, dual contra-rotating, coaxial rotor system aircraft, turbo-props, tilt-rotors and tilt-wing aircraft, will also benefit herefrom.

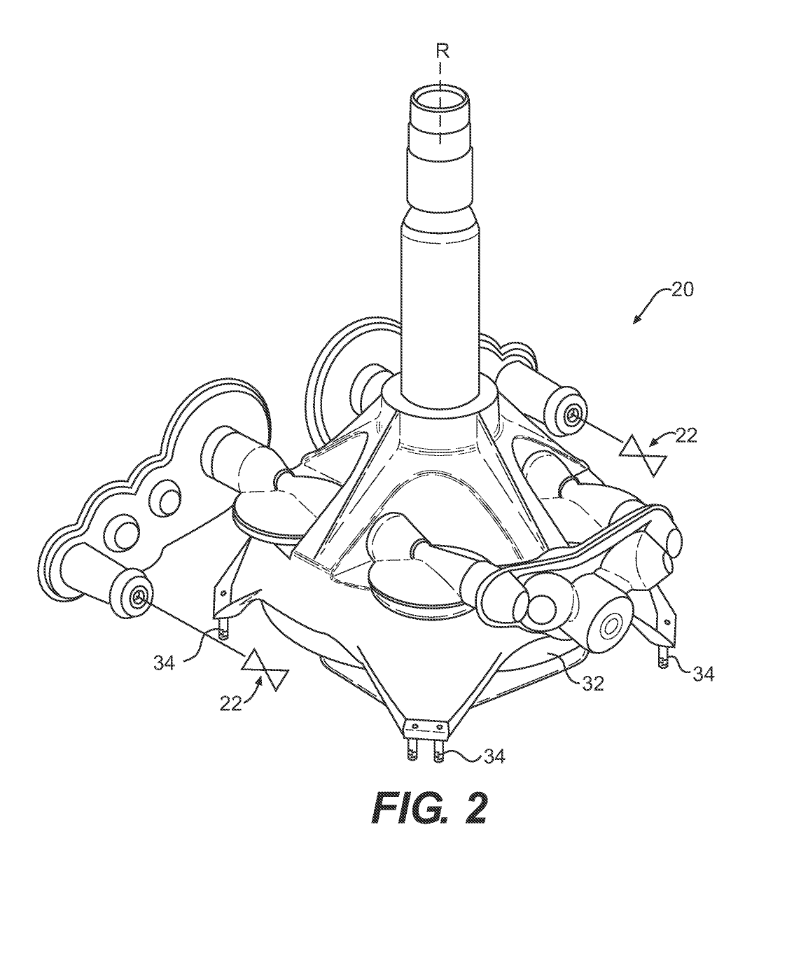

Referring to FIG. 2, the transmission 20 includes a transmission housing assembly 30. The transmission housing assembly 30 includes a component 32 such as a housing and hardware 34 mounted therein to, for example, mount the component 32 to anchoring structure(s) such as the airframe 14 (see FIG. 1). The hardware 34 may, in one non-limiting embodiment, be a stud, which is often referred to as Rosan Ring Locked Studs manufactured by Fairchild Fasteners of Dulles, Va., USA. The term “hardware” as utilized herein includes, but is not limited to, any type of hardware pressed into a bore, such as, for example only, pins, bushings, threaded inserts, locking rings, studs and such like.

The component 32 may be manufactured of one material such as magnesium while the hardware 34 may be manufactured of a different material such as titanium. Although a transmission housing is illustrated in the non-limiting embodiment of FIG. 2, it should be understood that any component which receives hardware into a bore therein will benefit herefrom. Furthermore, although a stud is illustrated in the disclosed non-limiting embodiment it should be understood that any insert will also benefit herefrom.

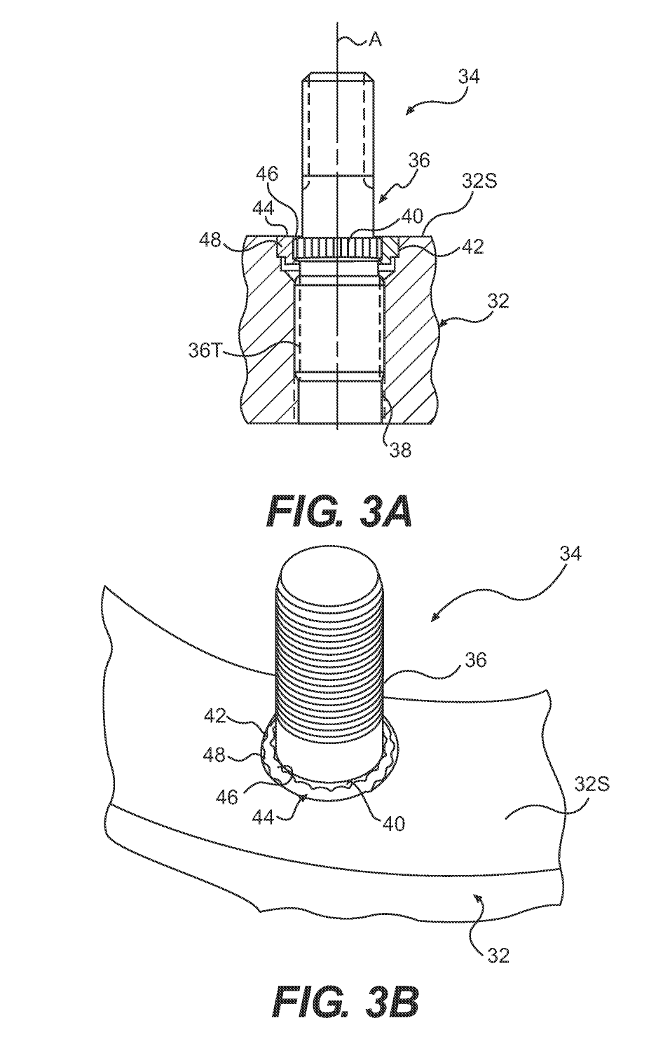

Referring to FIG. 3A, the hardware 34 includes a stud 36 having a threaded portion 36T about a stud axis A which may be threaded into a corresponding threaded bore 38 formed in the component 32. The stud 36 includes a serrated section 40 disposed about the stud outer diameter (OD) adjacent the threaded portion 36. A counter bore 42 is formed in the threaded bore 38 adjacent a housing surface 32S. The counter bore 42 is sized to receive a locking ring 44 (also illustrated in FIG. 3B).

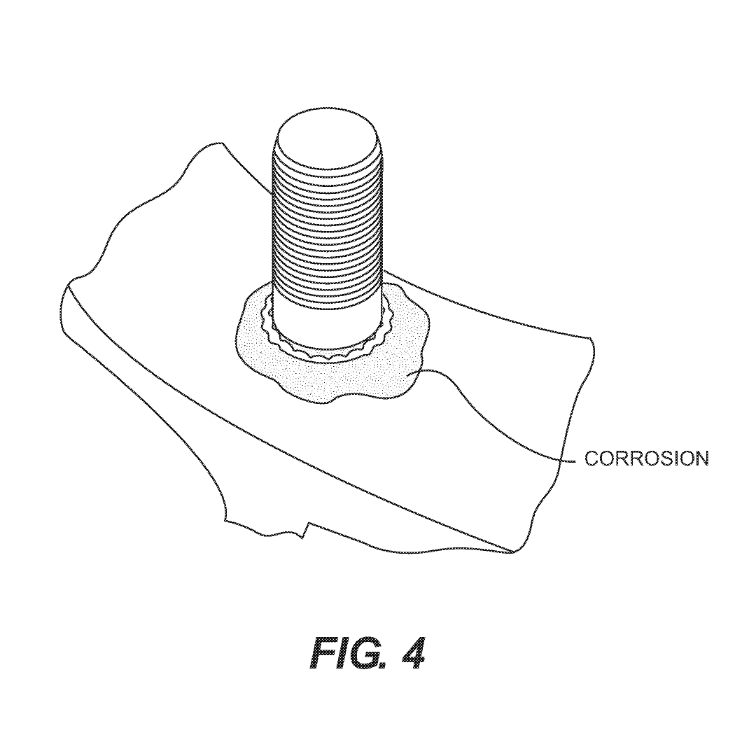

The locking ring 44 includes internal serrations 46 about an inner diameter (ID) which are arranged to engage the serrated section 40 of the stud 36 and external serrations 48 which facilitate engagement with the counter bore 42 (FIG. 3B). The locking ring 44 may be manufactured of a material different than both the stud 36 and the component 32 such as INCONEL 718, however, other materials may alternatively be utilized. The differential material types often result in corrosion which makes disassembly more difficult (FIG. 4).

The external serrations 48 are designed to be pressed into and thereby anti-rotationally secured into the counter bore 42. That is, the external serrations 48 allow the locking ring 44 to be swaged, interference fit, cut into or plastically deform the counter bore 42. Alternative and additional anti-rotational locking structure including locking plates and other threaded or splined components are contemplated herein including, but not limited to, mating keys, corresponding serration or serrations on one of either or both the ID or OD of the various components.

Depth alignment of the stud may be achieved through threading of the stud 36 into the threaded bore 38. The locking ring 44 is then pressed into the counter bore 42 to secure the stud 34 into the component 32 to prevent rotation therebetween.

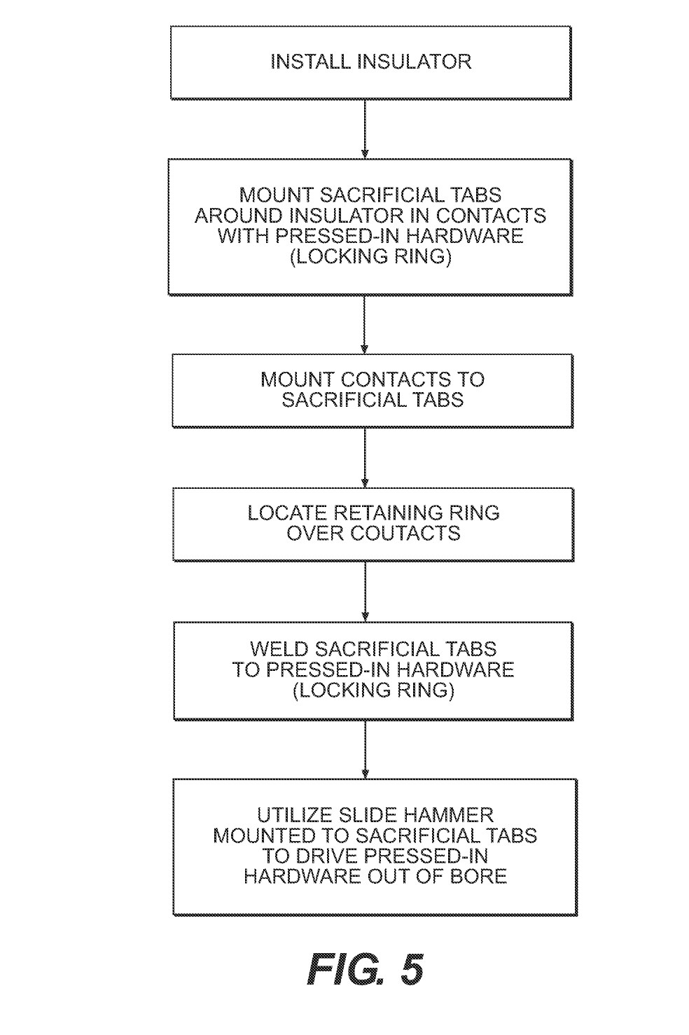

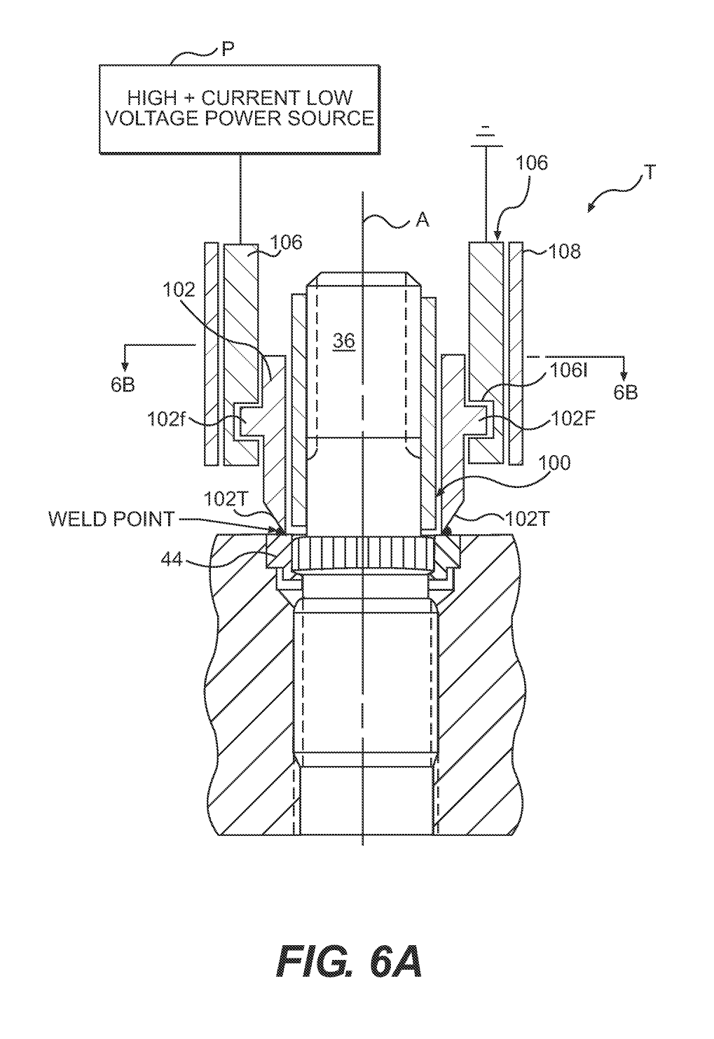

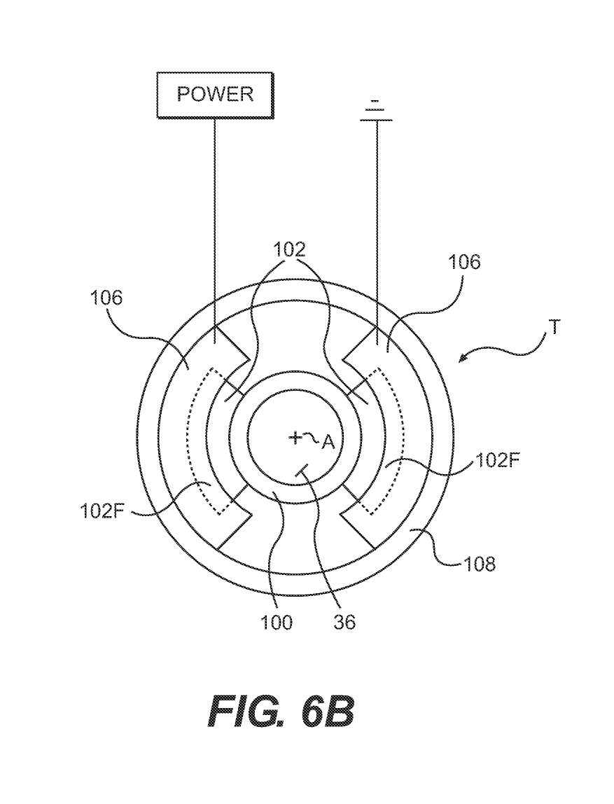

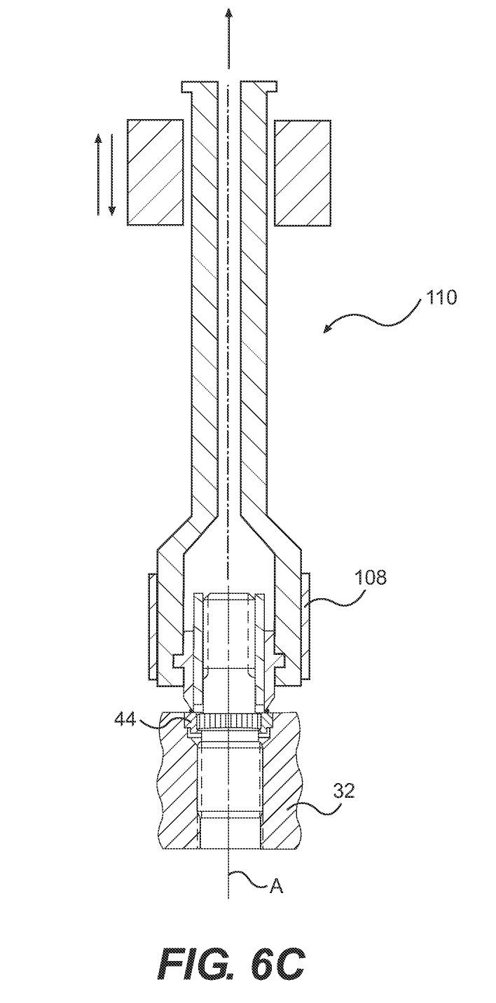

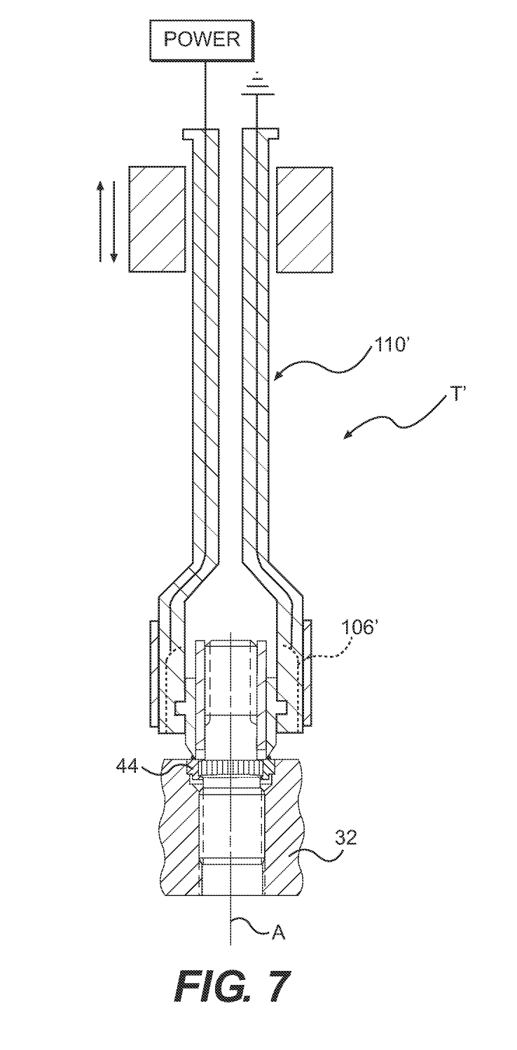

Referring to FIG. 5, a method to remove the locking ring 44 and thus the stud 36 is disclosed. This exemplary method to remove the locking ring 44 is achieved with a tool assembly T (see FIGS. 6A, 6B, 6C and 7).

Referring to FIGS. 6A and 6B, the tool assembly T includes an insulator 100 mountable over the stud 36. The insulator 100 electrically insulates and may additionally thermally insulate the stud 36. Sacrificial tabs 102 are then mounted around the insulator 100 to contact the locking ring 44. The sacrificial tabs 102 may be manufactured of copper plated steel segments that are generally arcuate in cross-section (FIG. 6B). The sacrificial tabs 102 further include a flange 102F generally transverse to the axis A and a chisel tip 102T to provide a focused weld point. It should be understood that the sacrificial tabs 102 may be of various shapes.

Each of a set of contacts 106 includes an interface 106I, such that the interfaces 106I are mounted around the sacrificial tabs 102 and engage the respective flanges 102F. The set of contacts 106 may include at least two contacts 106 to provide for a high current low voltage power attachment and a ground contact. The contacts 106 may be at least partially arcuate in lateral cross-section (FIG. 6B). A retaining sleeve 108 is located axially over the interface 106I to radially retain the contacts 106 to the respective flanges 102F. The contacts 106 are in electrical communication with a power source P to weld the sacrificial tabs 102 to the locking ring 44.

The retaining sleeve 108 and the contacts 106 may then removed such that a slide hammer 110 (FIG. 6C) may be mounted to the sacrificial tabs 102. The slide hammer 110 is then operated to hammer the sacrificial tabs 102 and attached locking ring 44 axially along axis A to remove the locking ring 44 from the component 32. The slide hammer 110 may be manufactured in radial segments to facilitate mounting to the contacts 106.

In another non-limiting embodiment, the contacts 106 may form a portion of the slide hammer 110′ (FIG. 7) such that the hammering operation may occur directly after the welding operation without the above described disassembly.

The tool assembly increases overhaul and repair cycle time; eliminates damage to the high value component; and prevents damage to the studs such that the studs may be reinstalled. Furthermore, the ability to readily remove the studs facilitates more robust repair procedures to the high value base structure when the studs and inserts are removed.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A method of removing hardware from a bore in a component, comprising:
welding at least one sacrificial tab to the hardware while the hardware is within the bore, the bore defined along an axis; and
axially forcing, by using at least the at least one sacrificial tab, the hardware from the bore along the axis.

2. The method as recited in claim 1, wherein the welding comprises welding a first sacrificial tab and a second sacrificial tab to the hardware.

3. The method as recited in claim 2, wherein the first sacrificial tab and the second sacrificial tab are partially arcuate in cross-section.

4. The method as recited in claim 3, further comprising:
locating an insulator about a stud retained by the hardware.

5. The method as recited in claim 4, further comprising:
locating a first electrical contact in contact with the first sacrificial tab;
locating a second electrical contact in contact with the second sacrificial tab;
retaining the first sacrificial tab and the second sacrificial tab about the insulator with a retaining sleeve; and
passing an electrical current through the first and the second electrical contacts.

6. The method as recited in claim 1, wherein the axially forcing comprises:
engaging an impact hammer with a flange which extends from the at least one sacrificial tab generally transverse to the axis; and
using the impact hammer to axially force the hardware from the bore.

7. The method as recited in claim 6, further comprising:
passing an electrical current through the impact hammer to weld the at least one sacrificial tab to the hardware.

8. The method as recited in claim 1, further comprising locating the at least one sacrificial tab about a stud, the at least one sacrificial tab at least partially arcuate in cross-section.

9. A method of removing a locking ring which axially retains a stub within a bore in a component, comprising:
locating an insulator about a stud retained by the locking ring;
locating a first sacrificial tab adjacent the insulator in contact with the locking ring;
locating a second sacrificial tab adjacent the insulator in contact with the locking ring;
locating a first electrical contact in contact with the first sacrificial tab;
locating a second electrical contact in contact with the second sacrificial tab;
retaining the first electrical contact in contact with the first sacrificial tab and the second electrical contact in contact with the second sacrificial tab about the insulator with a retaining sleeve;
passing an electrical current through the first and the second electrical contact to weld the first sacrificial tab and the second sacrificial tab to the locking ring while the locking ring is within the bore of the component, the bore defined along an axis; and
axially forcing, by using at least the first and second sacrificial tabs, the locking ring from the bore along the axis.

10. The method as recited in claim 9, wherein the axially forcing comprises:
engaging an impact hammer with a plurality of flanges, each flange part of one of the sacrificial flanges and extending, generally transverse to the axis, from the associated sacrificial tab.

11. The method as recited in claim 10, further comprising:
utilizing the first electrical contact and the second electrical contact as a portion of the impact hammer.

12. A tool assembly for removing hardware from a bore in a component, comprising:
a set of contacts which form at least a portion of an impact hammer along an axis and which are configured to contact the hardware in the bore; and
a power source in communication with said set of contacts to weld said set of contacts to the hardware.

13. The assembly as recited in claim 12, further comprising:
at least one sacrificial tab, each of said at least one sacrificial tabs partially arcuate in cross-section.

14. The assembly as recited in claim 12, further comprising:
at least one sacrificial tab, each of said at least one sacrificial tabs having a flange which extends from the sacrificial tab generally transverse to said axis.

15. The assembly as recited in claim 14, wherein said set of contacts includes an interface engageable with said flange.
